(19) United States
(12) Patent Application Publication
(10) Pub. No.: US 2026/0300114 A1
(43) Pub. Date: Oct. 1, 2026

(54) IN-FIELD STRUCTURAL TESTING

(71) Applicant: Arm Limited, Cambridge (GB)

(72) Inventors: Kar-Lik Kasim WONG, Ealing (GB); Peter Andrew Rees WILLIAMS, Great Abington (GB); Colin OSBORNE, Cambridge (GB); Prashant Mohan KULKARNI, Cambridge (GB)

(21) Appl. No.: 19/577,742

(22) Filed: Mar. 25, 2026

(30) Foreign Application Priority Data
Mar. 26, 2025 (GB) 2504383.7

(51) Int. Cl. G06F 11/26; G06F 9/48; G06F 9/50; G06F 11/20

(52) U.S. Cl. CPC G06F 11/26; G06F 9/4856; G06F 9/5072; G06F 11/203; G06F 11/2041

(57) ABSTRACT

A method for a processing system comprising a plurality of compute tiles, comprises: processing a distributed processing workload using a first subset of the compute tiles operating in an operational state, while a second subset of compute tiles of the integrated circuit are in a non-operational state unused for processing the distributed processing workload; and in response to a test trigger event indicating that a test target compute tile of the first subset is to be selected for in-field structural testing of the test target compute tile: substituting a spare compute tile from the second subset of compute tiles for the test target compute tile, to switch the spare compute tile to become one of the first subset of compute tiles configured to process the distributed processing workload in the operational state and switch the test target compute tile to become one of the second subset of compute tiles in the non-operational state; and performing the in-field structural testing on the test target compute tile.

The present technique relates to the field of integrated circuits. In particular, the technique relates to in-field structural testing.

An integrated circuit having a given set of functional circuitry (circuitry implementing the main functionality for which the integrated circuit is intended to be used when in operation in the field), may also include DFT (design for test) circuitry. The DFT circuitry may be additional hardware logic which is not needed for the main functionality itself, but which assists with testing the functional circuitry for structural defects or other errors. This can be used to support in-field structural testing of the functional circuitry, where once the integrated circuit is in operational use in the field (having left the manufacturing site where the integrated circuit is manufactured), the device can self-test for hardware defects that may have escaped detection during manufacture or may have developed at a subsequent time due to semiconductor aging effects or wearout. Providing support for in-field structural testing can improve reliability for electronic devices by reducing risk of processing errors that are caused by defective hardware components of an integrated circuit remaining undetected.

At least some examples of the present technique provide a method for a processing system comprising a plurality of compute tiles, comprising: processing a distributed processing workload using a first subset of the compute tiles operating in an operational state, while a second subset of compute tiles of the integrated circuit are in a non-operational state unused for processing the distributed processing workload; and in response to a test trigger event indicating that a test target compute tile of the first subset is to be selected for in-field structural testing of the test target compute tile: substituting a spare compute tile from the second subset of compute tiles for the test target compute tile, to switch the spare compute tile to become one of the first subset of compute tiles configured to process the distributed processing workload in the operational state and switch the test target compute tile to become one of the second subset of compute tiles in the non-operational state; and performing the in-field structural testing on the test target compute tile.

At least some examples of the present technique provide a computer program comprising instructions which, when executed on a processing system control the processing system to perform the method described above. The computer program can be stored on a computer-readable storage medium. The computer-readable storage medium may be a non-transitory storage medium.

At least some examples of the present technique provide an apparatus comprising: a plurality of compute tiles configured to process a distributed processing workload using a first subset of the compute tiles operating in an operational state, while a second subset of compute tiles of the integrated circuit are in a non-operational state unused for processing the distributed processing workload; and in-field structural testing infrastructure configured to control in-field structural testing of the test target compute tile; wherein, in response to a test trigger event indicating that a test target compute tile of the first subset is to be switched from the operational state to the non-operational state to support in-field structural testing of the test target compute tile, in-field structural testing infrastructure is configured to: substitute a spare compute tile from the second subset of compute tiles for the test target compute tile, to switch the spare compute tile to become one of the first subset of compute tiles configured to process the distributed processing workload in the operational state and switch the test target compute tile to become one of the second subset of compute tiles in the non-operational state; and control the in-field structural testing to be performed on the test target compute tile.

At least some examples of the present technique provide a system comprising: the apparatus described above, implemented in at least one packaged chip; at least one system component; and a board, wherein the at least one packaged chip and the at least one system component are assembled on the board.

At least some examples of the present technique provide a chip-containing product comprising the system described above, wherein the system is assembled on a further board with at least one other product component.

At least some examples of the present technique provide computer-readable code for fabrication of an apparatus as described above. The computer-readable code may be stored on a computer-readable storage medium. The computer-readable storage medium may be a non-transitory storage medium.

Further aspects, features and advantages of the present technique will be apparent from the following description of examples, which is to be read in conjunction with the accompanying drawings, in which:

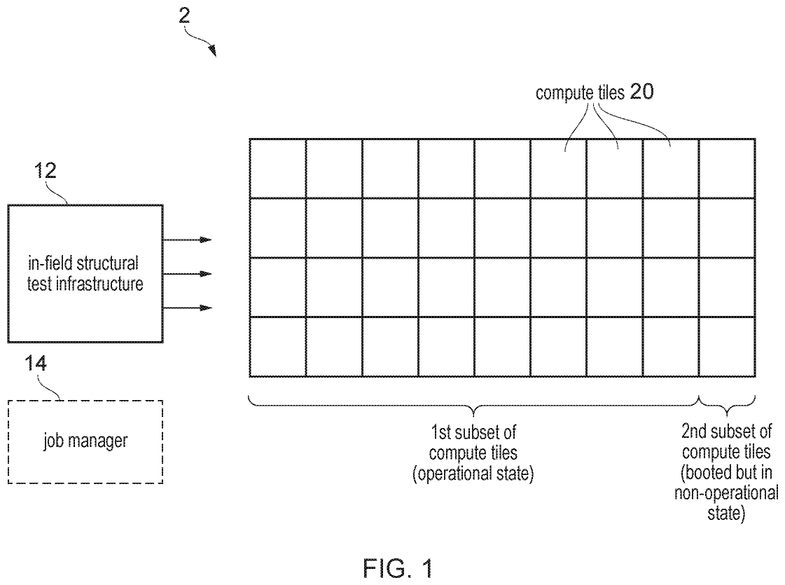

FIG. 1 illustrates an example of an apparatus comprising compute tiles and in-field structural test infrastructure;

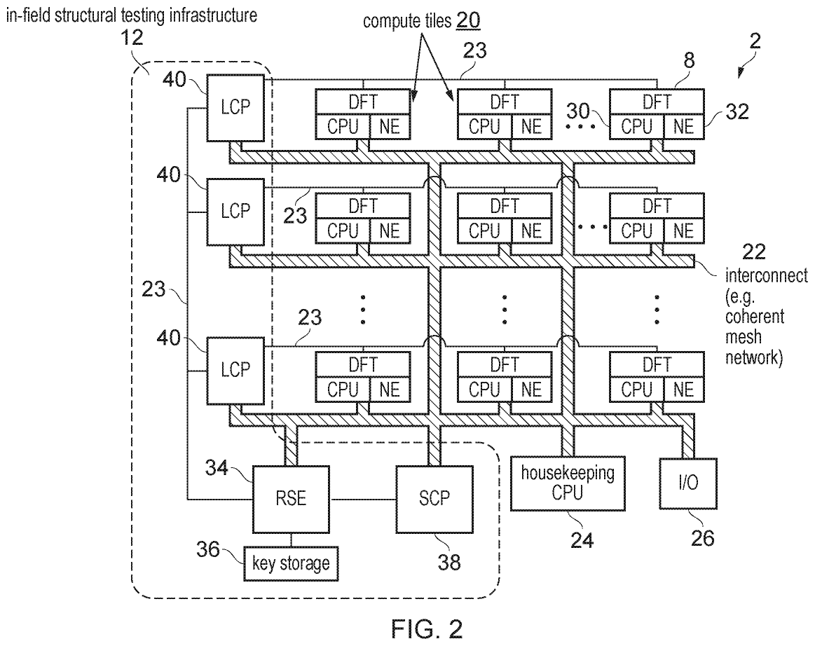

FIG. 2 illustrates a specific example apparatus comprising compute tiles, each compute tile comprising a tile central processing unit (CPU) and a hardware accelerator;

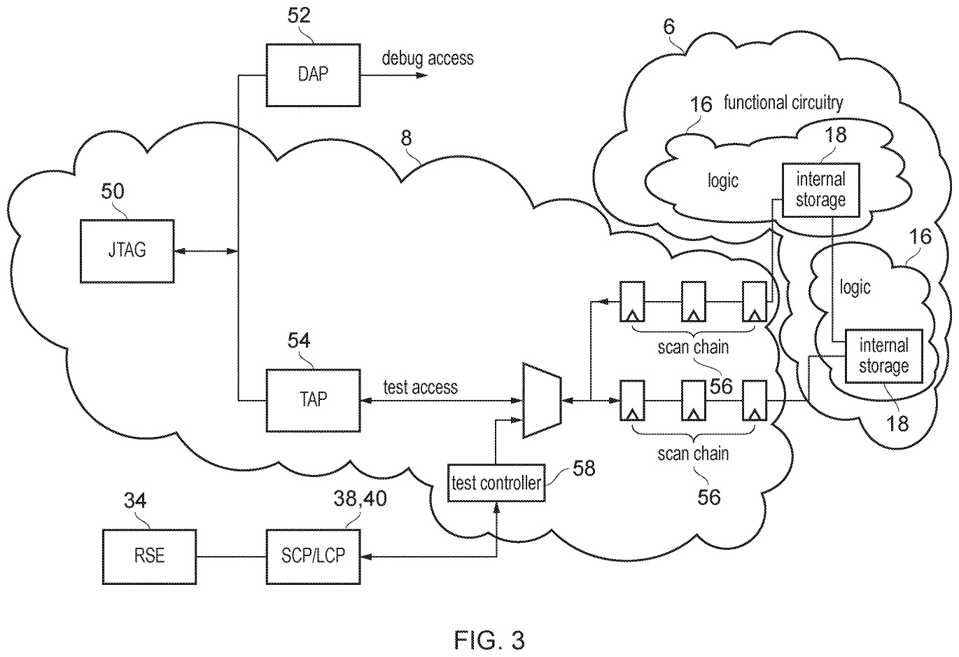

FIG. 3 illustrates an example of DFT circuitry including scan chains for injecting test values into internal storage elements of functional circuitry (e.g. the internal storage elements may comprise flip-flops);

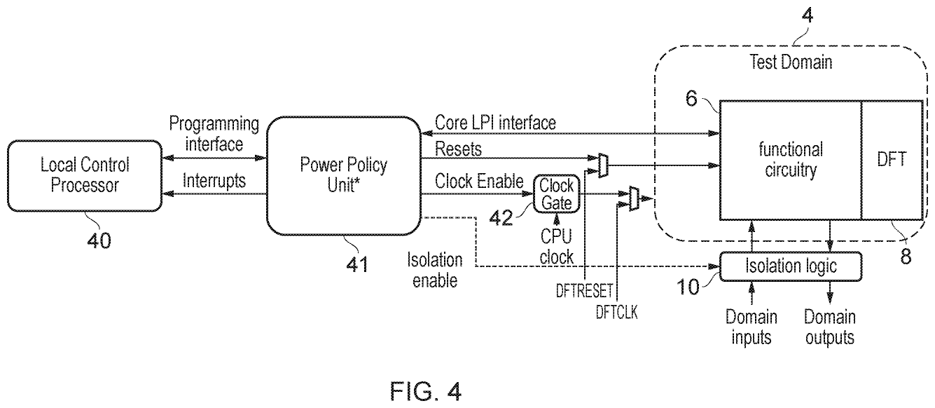

FIG. 4 illustrates isolation circuitry for isolating domain boundary signals of a test domain from other domains that could interfere with testing of the test domain and functional operation in the other domains;

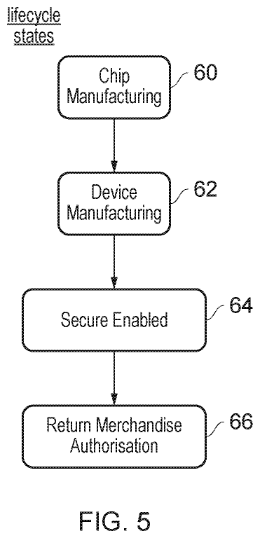

FIG. 5 illustrates an example of transitions between lifecycle states associated with different permissions for use of the DFT circuitry;

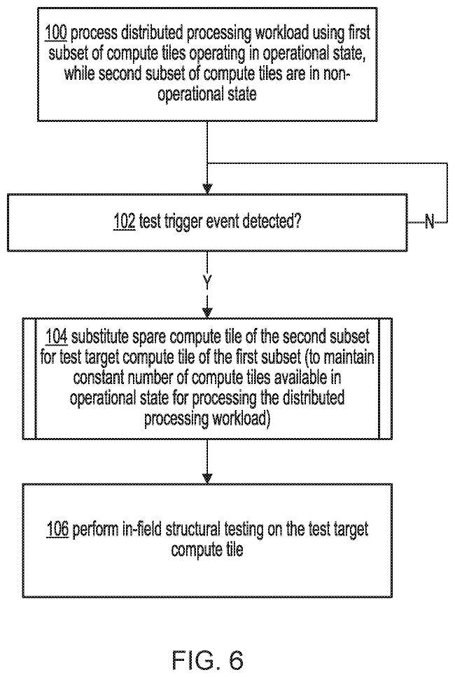

FIG. 6 illustrates steps including substitution of a spare compute tile for a test target compute tile to enable in-field structural testing of the test target compute tile;

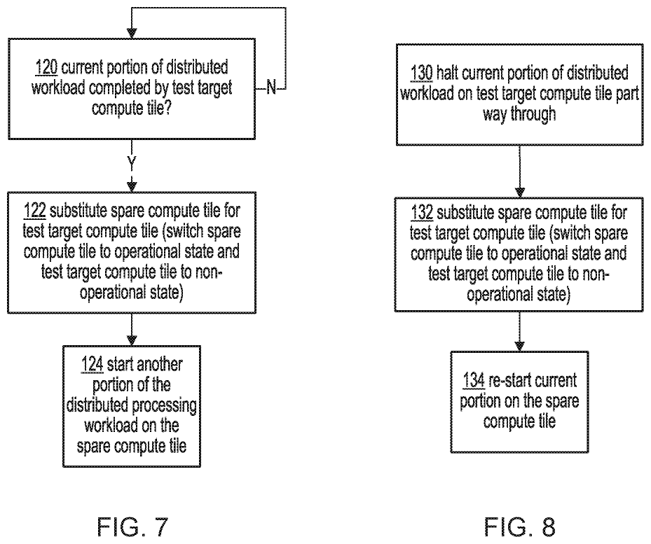

FIGS. 7 and 8 illustrate alternative approaches for controlling the substitution of the spare compute tile and the test target compute tile;

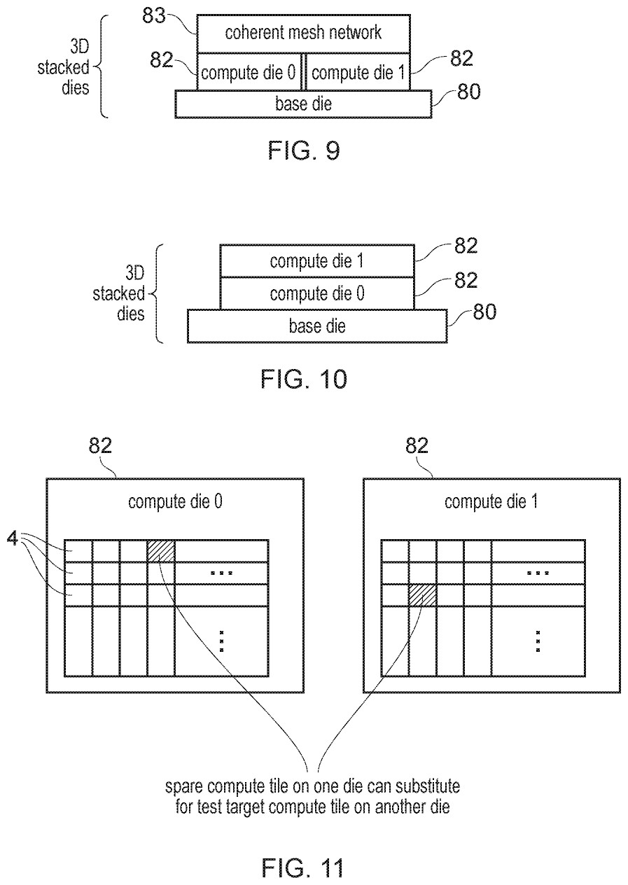

FIGS. 9 and 10 illustrate examples of an apparatus comprising two or more compute dies comprising compute tiles;

FIG. 11 illustrates an example of substituting a spare compute tile on one die for a test target compute tile on another die; and

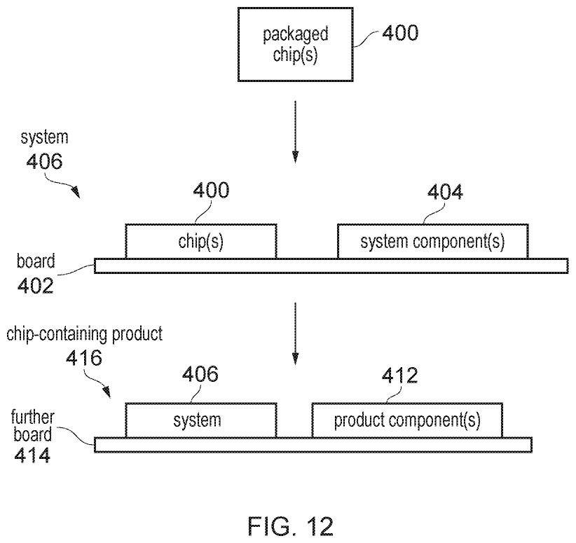

FIG. 12 illustrates a system and a chip-containing product.

A method comprises processing a distributed processing workload on an apparatus comprising a number of compute tiles. The total number of compute tiles provided in the apparatus in hardware can be greater than the number of compute tiles used at a given time for performing the distributed processing workload. Hence, the compute tiles can include a first subset of the compute tiles operating in an operational state, and a second subset of compute tiles of the integrated circuit which are in a non-operational state unused for processing the distributed processing workload.

In an integrated circuit die comprising a number of compute tiles, one approach for protecting against hardware faults can be to provide some spare compute tiles which can be substituted for a faulty compute tile if a hardware fault is detected for the faulty compute tile. Due to manufacturing defects that may arise in manufacture of an integrated circuit die (which may arise randomly due to manufacturing-time variation), the yield of a manufactured set of dies which are defect-free is less than 100%. It can be more economical for a manufacturer to design the die with more tiles than are really required for processing the expected workloads, so that a die with a small number of faulty tiles can avoid being discarded as it can still function as long as it has the minimum required number of fully functional tiles.

Normally, such spare compute tiles are used purely for dealing with faulty tiles that can no longer function correctly. However, the inventors proposed a different use for spare compute tiles, to support performing in-field structural testing on a test target compute tile while preserving sufficient computational resource available for the distributed processing workload to continue while the testing is being performed on the test target compute tile. In-field structural testing enables the functional circuitry of the test target compute tile to be tested for hardware faults once the device is operational in the field, so that any defects that escaped detection at manufacturing or which have arisen subsequently due to semiconductor device aging effects can be detected and prevented from causing processing errors.

Hence, in response to a test trigger event indicating that a test target compute tile of the first subset is to be selected for in-field structural testing of the test target compute tile, the method comprises substituting a spare compute tile from the second subset of compute tiles for the test target compute tile, to switch the spare compute tile to become one of the first subset of compute tiles configured to process the distributed processing workload in the operational state and switch the test target compute tile to become one of the second subset of compute tiles in the non-operational state. The in-field structural testing can then be performed on the test target compute tile.

This approach can be seen as counter-intuitive because the provision of known good spare tiles is normally seen as a countermeasure against permanent hardware faults being detected, rather than a measure for maintaining level of service for a distributed workload while temporarily conducting structural testing on a compute tile which is not necessarily faulty. However, the inventors recognised that for some workloads (e.g. processing of machine learning models such as large language models, LLM), it can be important to maintain a given number of compute tiles available in the first subset when processing the workload, as re-partitioning the workload to operate on fewer tiles would be extremely onerous for the job manager managing that workload, and performance would suffer significantly if even one compute tile becomes unavailable from the set of compute tiles designated for processing the distributed workload. Moreover, for some use cases it can be desirable to enable part of the integrated circuit die to be subjected to in-field structural testing while another part remains available for functional processing, as there can be some fields of application where “always on” availability is desired, e.g. in a server offering a cloud service or for acceleration of data-intensive workloads such as machine learning processing. Therefore, it can be useful for such workloads to provide known good spare tiles that are not actively used for the distributed processing workload initially (so are initially in the second subset of compute tiles) but which can be brought into operation to compensate for a tile of the first subset which is being brought offline to perform in-field structural testing. This helps maintain the expected levels of service for the distributed workload while supporting the ability to perform in-field structural testing without having to bring the whole system offline.

In some examples, substituting the spare compute tile for the test target compute tile maintains a constant number of compute tiles available in the operational state for processing the distributed processing workload.

Both the concept of substituting a known good spare tile for the test target compute tile (where the test target compute tile is not yet known to be faulty at the time it is brought offline for testing), and the concept of maintaining a constant number of compute tiles in the operational state at a given time available for processing the distributed processing workload, may be considered to be counter-intuitive, since this would imply that some non-faulty tiles are intentionally left unused even though they are non-faulty and could be brought operational for supporting the distributed processing workload. One might expect that it would be preferable to use all available non-faulty compute tiles as part of the first subset of compute tiles, so that at least a minimum number of compute tiles is available in the operational state (but sometimes the number of operational compute tiles in the first subset exceeds that minimum number).

However, the inventors recognised that, for some workloads (e.g. machine learning workloads such as LLM training or inference algorithms), a defined constant number of compute tiles being available in the operational state may be preferred (even if some other compute tiles are non-faulty and could have been available as additional tiles). This may be for a number of reasons. Firstly, the job manager which dispatches portions of the distributed workload to respective compute tiles may be relatively complex to implement, and if the number of available compute tiles is variable over time then this may make the job manager process even more complex. The job management can be much simpler if it can assume that there is always a constant number of compute tiles available. Also, some workloads may be heavily inter-dependent so that when distributed across a number of compute tiles, the portion of the workload on one compute tile may depend on outputs calculated by many other portions of the workload executed on other compute tiles. Hence, if one compute tile was brought offline for testing and not compensated for by replacing that compute tile with a substitute compute tile, portions of the workload on various other compute tiles may become stalled because they are waiting for the results calculated by the portion of the workload previously allocated to the compute tile brought off-line for testing. Given the level of inter-dependence between sub-portions of the distributed workload, it may be preferable to implement a one-for-one substitution of the known good spare compute tile for the test target compute tile so that the decision to bring the test target compute tile offline for testing does not impact on the forward progress of other compute tiles. Hence, for these reasons, it can be particularly helpful to support substitution of the spare compute tile for the test target compute tile when the test target compute tile is chosen for testing, and to manage the membership of the first and second subsets of compute tiles so that (provided the number of faulty compute tiles does not exceed a threshold) a constant number of compute tiles in the operational state (first subset) are available at any given time.

In some examples, the first subset of the compute tiles are selected from among a booted subset of compute tiles booted at boot time of the processing system, and the booted subset comprises a greater number of compute tiles than said constant number functionally required by the workload. This allows an operating system executing on the device to be aware of all compute tiles that are available for processing the distributed workload, so that it can bring the test target compute tile offline for testing and make the spare compute tile active as a substitute. Booting more compute tiles than are actually needed for supporting the distributed workload would be quite unusual even in a system which supports use of known good spare compute tiles for the purpose of substituting for faulty tiles (in that case, when a hardware fault is detected in a faulty tile, the system would typically be rebooted in order to substitute a good spare for the faulty tile, so the boot process would only boot up the required number of tiles, not a greater number of tiles than the required number).

In some examples, each compute tile comprises at least one tile CPU. Hence, the apparatus having the tiles may provide a cluster of compute tiles each with at least one CPU, so that parallel processing of distributed workloads is possible. With a tiled arrangement, a modular approach can be used to design an integrated circuit having a given amount of computational resource. In some examples, each compute tile may have the same functional design. Some examples may provide each compute tile with the same physical layout, e.g. with tiles laid out in a regular array (e.g. grid) pattern, each element of the array comprising equivalent circuit logic. Other examples may not necessarily use the same physical layout for each compute tile, but may provide logically identical compute tiles (tiles having the same functional components, even if laid out differently on a chip). It is also possible to include multiple types of compute tile, so that not all compute tiles are necessarily the same. For example, respective types of compute tiles could support different types of processing circuitry (e.g. with different variants of execution unit and/or hardware accelerator support). It may also be possible to provide compute tiles with different performance characteristics (e.g. with different pipeline widths, queue sizes, datapath widths, or cache configuration), to allow trade-offs of computational power against energy costs by selecting between a more energy-efficient, but lower performance, compute tile, and a higher performance, but more power-hungry, compute tile. Hence, there are a variety of options for implementing the compute tiles. Nevertheless, in general using a tiled arrangement where a system is built up from a number of compute tiles, each compute tile including (at least) a tile CPU, can be helpful to provide a system which is scalable to different performance requirements by varying the number of compute tiles provided. Hence, in some examples the compute tiles may support a modular design and particular implementations may vary the number of compute tiles provided. In some cases, the number of compute tile may be of the order of hundreds, thousands or even millions of compute tiles.

In some examples, each compute tile also comprises a hardware accelerator. Hence, each compute tile may comprises both the at least one tile CPU and an associated hardware accelerator. The hardware accelerator may support performing a task offloaded by a given tile CPU asynchronously relative to the operations performed by the given tile CPU itself. A hardware accelerator provides hardware circuitry supporting a certain class of specialized operations, which can be performed more efficiently by the hardware accelerator in hardware than could be performed in software using instructions of a general purpose instruction set supported by a CPU. The accelerator may be designed for a particular purpose, rather than for general purpose processing. The accelerator could comprise fixed-function circuit logic, or alternatively could have some degree of programmability, although with less flexibility in terms of the operations supported than would be supported by a general purpose CPU. For example, the accelerator may support a limited set of complex functions each corresponding to a certain combination of low-level functions such as arithmetic/logical operations rather than implementing the complex function with a sequence of instructions, each instruction performing a basic arithmetic/logical operation. The accelerator may be incapable of execution of an operating system (in contrast to the tile CPU which may support operational system execution). Each compute tile has at least one hardware accelerator. In some examples, a compute tile could include more than one hardware accelerator (e.g. two or more accelerators supporting different classes of operations). Hence, some tiles may have one tile CPU associated with multiple hardware accelerators. However, some implementations may support a one-to-one mapping between tile CPUs and hardware accelerators.

The hardware accelerator on each compute tile could implement a variety of classes of processing operations as the specialized operations implemented using the accelerator. For example, the accelerator could implement algorithms for digital signal processing, cryptographic functions, data compression, physics simulation, etc. However, the use of a cluster of compute tiles, with support for substitution of a spare compute tile for the test target compute tile being subject to structural testing as discussed above, can be particularly useful where the hardware accelerator comprises accelerator circuitry configured to accelerate operations for one or more machine learning workloads. For example, the hardware accelerator may comprise a machine learning accelerator, also known as an artificial intelligence (AI) accelerator, neural processing unit (NPU), or neural engine. The computational demands of machine learning applications are rapidly growing, so high-performance support for machine learning workloads is increasingly important. Many machine learning problems, such as processing of a prompt supplied to a large language model (LLM), may involve the problem to be decomposed into multiple sub-problems (e.g. a complex prompt can be decomposed into a number of simpler prompts). Each sub-problem may be capable of acceleration using a machine learning accelerator, so it can be beneficial to performance to be able to parallelize machine learning tasks using a cluster of compute tiles each comprising respective hardware accelerators. Such machine learning tasks are particularly sensitive to inter-compute tile dependencies and may be complex for a job manager to partition into sub-portions, so may benefit from a constant number of compute tiles being available in the first subset at any given time while the distributed workload is being processed. Therefore, the techniques discussed in this patent application can be particularly useful when applied to a set of compute tiles each comprising a machine learning accelerator associated with a tile CPU.

There can be a number of ways in which the substitution of the spare compute tile for the test target compute tile can be performed. One might expect that when substituting the spare compute tile for the test target compute tile, it may be needed to perform context save/restore operations to save context information from the test target compute tile to memory and restore that context information from memory to the spare compute tile before the spare compute tile can resume processing the portion of the distributed workload that was previously been performed on the test target compute tile. However, the inventors recognised that, especially for compute tiles comprising accelerators (in particular machine learning accelerators), the amount of internal state information representing the current context of the compute tile may be relatively large and so the context save/restore operation may be costly in terms of energy consumption and latency.

In practice, a job manager partitioning the distributed processing workload among compute tiles may split the distributed processing workload into relatively small chunks where the running time for any given chunk is relatively short (nevertheless the amount of internal state stored internally within a given compute tile assigned one of those chunks may still be large if the chunk was to be interrupted part way through and resumed later on another compute tile). Since the running time for any individual chunks allocated to a particular compute tile may be relatively short, this opens up opportunities to schedule the testing of a given test target compute tile in such a way that the substitution of the spare compute tile for the test target compute tile is carried out at the time when the test target compute tile has either finished processing a given chunk, or will nevertheless not need any internal context information to be preserved for the spare compute tile. This avoids the latency cost of the context save/restore operations for the accelerator (which would be harmful to overall latency for the distributed processing workload as a whole, as many other compute tiles might be waiting for the result of the portion of the distributed processing workload previously assigned to the test target compute tile). Scheduling the test process to avoid such context save/restore operations can be achieved in different ways.

In some examples, the method comprises, in response to the test trigger event: waiting for completion of a current portion of the distributed processing workload to be completed by the test target compute tile; and upon completion of the current portion by the test target compute tile, substituting the spare compute tile for the test target compute tile and starting another portion of the distributed processing workload on the spare compute tile. Hence, with this approach the substitution of the spare compute tile for the test target compute tile does not significantly interrupt a portion of the distributed processing workload partway through, but instead waits for a natural break in processing (at a time when the amount of internal state to be preserved can be minimised) so that there is no need to preserve a potentially large amount of temporary context information arising from the portion of the distributed processing workload performed on the test target compute tile. The test controller simply waits for the test target compute tile to finish its current portion of processing and then switches out the test target compute tile for the spare compute tile before resuming the next portion of the distributed processing workload on the spare compute tile. This greatly reduces the latency of performing context save/restore operations when switching out the test target compute tile to replace it with the spare compute tile.

Alternatively, the method may comprise, in response to the test trigger event: halting a current portion of the distributed processing workload part way through processing of the current portion on the test target compute tile; substituting the spare compute tile for the test target compute tile; and re-starting, from a beginning of the current portion, the current portion on the spare compute tile. With this approach, the test target compute tile can be interrupted partway through processing its current portion of the distributed processing workload, but nevertheless there is no need to preserve the internal context arising on the test target compute tile from the forward progress made in that portion of the distributed processing workload, because the current portion is simply re-started from the beginning on the spare compute tile (i.e. repeating parts of the current portion of the workload that were already done by the test target compute tile). While duplicating effort in repeating processing on the spare compute tile that was already done by the test target compute tile may seem inefficient, in practice the extra latency incurred by repeating that processing on the spare compute tile may be less than the extra latency that would be incurred by any context save/restore operations required for transferring internal context information from the test target compute tile to the spare compute tile, so overall it may be more efficient to simply kill the current portion of the workload part-way through and re-start it on the spare compute tile.

In some examples, the processing system comprises a plurality of integrated circuit dies, each comprising some of the compute tiles. In some examples, substitution of the spare compute tile for the test target compute tile may be limited to cases where the test target compute tile and the spare compute tile are on the same integrated circuit die.

However, in some examples, the test target compute tile and the spare compute tile can on different integrated circuit dies of the plurality of integrated circuit dies. By supporting the ability to substitute a spare compute tile on a first die for a test target compute tile on a second die, this gives more flexibility to deal with cases where faulty tiles arise disproportionately on one die rather than another, since it then still becomes possible to switch out tiles for testing on the die having the greater number of faulty dies by substituting the test target compute tile with a spare compute tile from another die. Hence, this gives greater fault tolerance.

In cases where the test target compute tile and the spare compute tile being substituted can be on different dies, it can be simpler to implement the substitution if the dies being substituted are coupled via a shared memory system interconnect (rather than on different memory system interconnects). That shared memory system interconnect may comprise a coherent mesh network. The shared memory system interconnect could be implemented on a further stacked integrated circuit die which is in a different layer of a three-dimensionally stacked set of dies from the layer comprising at least one of the dies comprising the test target compute tile and spare compute tile. For example, the dies comprising the test target compute tile and spare compute tile could be side-by-side dies in the same layer, with the interconnect die being stacked on top of the compute tiles so as to benefit from faster inter-layer communications in the vertical layer of the die stack.

In some examples, each compute tile comprises functional circuitry and design-for-test (DFT) circuitry to provide test access to the functional circuitry for performing the in-field structural testing. The DFT circuitry may comprise at least one scan chain configured to inject test values into internal storage elements of the functional circuitry of the compute tile. Such scan chains can be useful to enable specific test patterns to be processed during the in-field structural testing, which might be difficult or inefficient for a test controller to cause to occur naturally when performing a software workload. In particular, the scan chains can be particularly useful for injecting test values into internal storage elements of a type which software is not directly able to address with a register or memory read/write operation (e.g. such internal storage elements can include pipeline slots for tracking pending instructions or operations being processed, or queue or buffer structures for tracking pending memory access requests). The in-field structural testing may comprise stimulating the functional circuitry according to a test sequence controlled by test software executing on at least one software-programmable processor. The test sequence may be controlled by the software-programmable processor controlling a test controller to inject a test pattern via a scan chain.

The in-field structural testing may comprise testing for hardware defects (as opposed to testing for software bugs or performance issues caused by badly or inefficiently written software code). For example, the hardware defects could include defects caused by semiconductor device aging effects which cause a previously correctly functioning chip to eventually encounter errors, e.g. due to electromigration or other causes of displacement of physical material on the chip, trapped charges, or deterioration due to thermal stress (the probability of such aging effects increases with the lifetime of the device). Another source of hardware defects could be hardware defects in the integrated circuit hardware that were not caught during manufacturing testing of the chip. With advances in semiconductor process technologies and increase in design complexity, structural testing performed during manufacturing testing often cannot detect all hardware faults that should be covered and such undetected hardware faults could cause computational errors in the affected integrated circuit dies deployed to the field. Test engineers could carry on improving structural tests after the chip is deployed to come up with tests with higher fault coverage and such tests could be used in in-field testing to detect hardware defects escaped detection at manufacture. Also, integrated circuit dies are designed to tolerate minor variation in circuit behaviour, and some circuits could marginally pass manufacturing testing because their variations are within the tolerated ranges, but when subjected to some aspects of semiconductor device aging in the field, such circuits could have out-of-range behaviours, especially if used under certain operating conditions and circuit activities such as a harsh environment operating at high temperature or subject to extreme radiation. Hence, a wide variety of causes of hardware defects could be probed using the in-field structural testing.

In some examples, the method can be controlled by software executing on a processor. Hence, a computer program can be provided, comprising instructions for controlling a processing system to perform the method described above.

In other examples, in-field structural testing infrastructure (implemented in hardware) may control the method described above. Hence, an apparatus may comprise the compute tiles and the in-field structural testing infrastructure, with the in-field structural testing infrastructure controlling substitution of the spare compute tile for the test target compute tile as explained earlier.

Specific examples are now described with reference to the drawings.

FIG. 1 schematically illustrates an example of an apparatus 2 (processing system) comprising a number of compute tiles 20 for supporting distributed processing of a workload. Each compute tile 20 comprises processing logic (e.g. at least one CPU) capable of software execution. The apparatus 2 also includes in-field structural test infrastructure 12 for controlling testing the compute tiles 20 for hardware faults when the apparatus 2 is operational in the field. A job manager 14 (e.g. software executing on a processor separate from the compute tiles 4) allocates portions of a distributed workload to a first subset of compute tiles operating in an operational state in which they are fully available for processing the distributed workload. Meanwhile, a second subset of the compute tiles 20 are booted up ready for processing, but are currently in a non-operational state in which the compute tiles 20 of the second subset are not used for processing the distributed workload. When the in-field structural test infrastructure 12 selects a given test target compute tile 20 of the first subset, which is to be subject to testing for hardware defects while the processing of the distributed workload continues on other tiles, the in-field structural test infrastructure 12 (implemented either as dedicated hardware, or as a programmable processor executing test software controlling the test operations, or as a set of distributed components including one or more programmable processors in combination with hardware such as a test controller and/or scan chains) substitutes a spare compute tile from the second subset of compute tiles for the test target compute tile selected from the first subset of compute tiles. The spare compute tile becomes one of the first subset of compute tiles used for the distributed processing workload, and the test target compute tile becomes one of the second subset of compute tiles and is subjected to test routines designated by the in-field structural test infrastructure for supporting detection of hardware defects. In this way, when a tile is taken offline for testing, a known good tile is brought online as a compensation. This switch can be carried out under control by an operating system, but invisible to application level software, so as to preserve a constant number of available compute tiles for the distributed processing workload.

FIG. 2 shows a more detailed example of an apparatus (e.g. a system on chip or an integrated circuit die within a multi-chip system) 2 comprising compute tiles 20 coupled via an interconnect 22 (e.g. a coherent mesh network). Each compute tile 20 comprises a corresponding tile CPU (central processing unit) 30 and an associated accelerator 32. The accelerator 32 of a given compute tile may support hardware acceleration of any class of processing functionality that can benefit from more dedicated hardware support to improve performance for accelerated functions compared to implementations using general purpose instructions executing on general purpose hardware of the tile CPU 30. Examples of functionality that could benefit from acceleration may include cryptographic algorithms, data compression/decompression algorithms, or digital signal processing. However, in one particular example the cluster of compute tiles 20 may be intended for acceleration of operations for implementing machine learning processing, e.g. for implementing the training and/or inference phase of a machine learning model (e.g. a large language model, LLM). For example, the accelerators may be artificial intelligence (AI) accelerators 32, e.g. a neural engine (NE) for accelerating processing of neural networks. Unlike operations performed synchronously by a CPU pipeline, the accelerator operations performed by the accelerator are performed asynchronously with respect to the CPU pipeline, yielding results at arbitrary timings relative to the instruction pipeline timings of the CPU pipeline. Each accelerator 32 is private to the associated tile CPU 30 on the same compute tile 20, and cannot be directly accessed by the CPUs 30 on other compute tiles. A dedicated CPU-accelerator interface is provided on each tile by which the tile CPU 30 can offload tasks to its associated accelerator(s) 32, separate from the interface by which the tile CPU 30 accesses memory via the interconnect 22.

Each compute tile 20 also comprises DFT (design for test) circuitry 8 for providing test access to the functional circuitry (e.g. the tile CPU 30 and accelerator 32) of the compute tile 20. This is discussed in more detail later with reference to FIG. 3. Although not explicitly shown in FIG. 2 for components of the apparatus 2 other than the compute tiles 20, other components of the apparatus 2 can also have similar DFT circuitry 8.

In addition to the compute tiles 20 comprising CPU-accelerator pairs 30, 32, the apparatus 2 also includes a housekeeping CPU 24, which lacks a corresponding accelerator 32. The housekeeping CPU 24 provides additional compute capacity for executing programs (such as the job manager 14 mentioned earlier) for managing accepting job requests from external sources outside the compute cluster shown in FIG. 2, decomposing the job requests into smaller sub-tasks and offloading the sub-tasks to individual tile CPUs 30.

The apparatus 2 also includes an input/output (I/O) interface 26 by which the cluster of compute tiles 20 can communicate with input/output devices such as peripherals or external data storage.

Also, the apparatus 2 comprises a number of system control elements used for controlling system functions such as boot-time startup, power states, security lifecycle transitions and DFT functionality. The apparatus 2 comprises a runtime security engine (RSE) 34 which acts as a secure processor node for securely managing transitions of lifecycle state of the device (the lifecycle state governing what actions are possible at a given time, in particular defining the conditions under which test access to the device can be provided by the DFT circuitry 8). The RSE 34 can also be responsible for establishing a root of trust for the apparatus 2 (e.g. initializing the certificates and keys associated with the device), and for implementing cryptographic protocols for verifying certificates supplied by external requesting agents (e.g. to check whether the agent is authorized to cause a given action to be performed by the apparatus 2) and/or for implementing attestation functions, to provide an attestation to an external requester demonstrating to the external requester that they can trust the compute tiles 20 and other components of the apparatus 2 to be correctly configured to do the intended function required by the external requester. The RSE 34 has associated key storage 36 which stores the cryptographic keys and certificates used to support lifecycle management, certificate verification and attestation functions.

The apparatus 2 also includes at least one system control processor 38, 40 for managing basic system control functions. In this example, the system control functionality is distributed, comprising a main system control processor 38 providing global system control functionality for the entire system 2, and a number of local control processors (LCP) 40 each associated with a subset of the compute tiles 20 for managing the system control functions for that subset of compute tiles 20. This enables greater parallelisation of system control functionality as the main system control processor 38 can offload system control functions to respective LCPs 40 associated with the different subsets of compute tiles 20. In other examples, the system control processor functionality could be implemented using a single secure processor node (e.g. the main system control processor 38 alone), so the particular combination of system control processor 38 and LCPs 40 shown in FIG. 2 is just one example and is not essential. The system control functions carried by the system control processor(s) 38, 40 may include initialisation/start up functions performed at boot time and power control functions for controlling power state.

The system control processor(s) 38, 40 may also be responsible for conducting in-field structural testing routines when a given compute tile 20 has its DFT circuitry 8 unlocked for testing. The system control processor 38/LCPs 40 are software-programmable processors, so the test patterns used during the in-field structural testing may be defined by the software running on the system control processor 38/LCPs 40, which may define scan chain patterns to be injected into a given test domain using the DFT circuitry 8 of that test domain 4, to cause the functional logic 6 (e.g. tile CPU 30 and accelerator 32) of that domain to perform test activity. A DFT bus network 23 may be provided by which the system control processor(s) 38, 40 (in this example, the LCPs 40) can supply an unlock request requesting that the DFT circuitry 8 in a given test domain is unlocked to enable in-field structural testing to be performed. The DFT bus network 23 in this example is separate from the main system interconnect 22 by which read/write transactions are issued by the compute tiles 20 to each other and to a memory system (the memory system not being shown in FIG. 2 for conciseness). In other examples, DFT unlock requests could be supplied over the main interconnect 22 rather than a separate bus network 23.

Hence, the system control processor(s) 38, 40 may be responsible for conducting the in-field structural testing, but the availability of such testing may be securely managed by the RSE 34, which acts as a root of trust controller which verifies a certificate provided by the requesting agent (e.g. the system control processor 38 itself, or another entity which requests that the system control processor 38 conducts testing) that is requesting test access to a given domain, to check whether it is safe to allow the DFT circuitry 8 in a given domain to be unlocked. Hence, the system control processor 38, LCPs 40 and RSE 34, and OS software executing on a processor such as the housekeeping CPU 24 may collectively be seen as an example of the in-field structural testing infrastructure 12, which manages testing for hardware defects in the compute tiles 20. Although not shown in FIG. 2 for conciseness, the in-field structural testing infrastructure 12 can also include some local DFT lock control circuitry located at each compute tile 20 which responds to signals (e.g. the unlock request) sent on the DFT bus network 23 by unlocking/locking access to the DFT circuitry 8 in the corresponding compute tile 20.

FIG. 3 shows an example of DFT circuitry 8 in more detail. The DFT circuitry 8 provides test access to a corresponding set of functional circuitry 6 of a given compute tile 20. The functional circuitry 6 includes various instances of functional circuit logic 16 implementing the main functionality of the functional circuitry 6 (e.g. the functional circuit logic 16 may include components of the tile CPU 30 and accelerator 32 discussed earlier). The functional circuitry 6 also includes combinational logic and various internal storage elements 18, such as flip-flops, latches, registers, caches, queue structures, buffer structures, etc.

The DFT circuitry 8 includes a test access port (TAP) 54 accessible via an external interface 50, such as a JTAG interface supporting the JTAG (Joint Test Action Group) standard for providing external access for test purposes. The external interface 50 may also be connected to other modules such that it can be used for other purposes when not performing structural testing (for example, the JTAG port 50 could be shared with a debug access port (DAP) which provides debug access to the functional circuitry 6). The external interface 50 may comprise a set of physical external interface pins at the boundary of an integrated circuit die, or logical pins defined at the boundary between independently designed regions within an integrated circuit die, by which the test/debug access ports 54, 52 can be exposed to an external requester. That requester could be an external hardware unit, or could be software executing on a processor such as the system control processor/LCP 38, 40.

The debug access port (DAP) 52 is used to provide debug access to processing components of the functional circuitry 6, such that a debugger can, when observing execution of a given program by processing circuitry (e.g. the tile CPU 30), halt execution at a particular point and then inject additional debug instructions to be executed by the processing circuitry to cause additional debug actions to be performed and/or check values of architectural state of the processing circuitry. The debug access is intended primarily for software developers to be able to verify that a given program is running correctly or efficiently on the functional circuitry, rather than for verifying whether there are any structural defects in the hardware of the functional circuitry 6.

On the other hand, the test access port (TAP) 54 provides test access for use during structural testing performed during a manufacturing phase. Also, a test controller 58 is provided to provide test access for use during in-field structural testing performed when the apparatus 2 is operational in the field. Whereas the DAP 52 may be restricted to accessing storage elements 18 which provide architecturally-defined values such as register state (which are architecturally meaningful to software developers as they are defined in an instruction set architecture (ISA) supported by the apparatus 2), the TAP 54 and test controller 58 may access scan chains 56 which enable test data to be written into micro-architectural internal storage elements 18 (e.g. flip-flops) which are specific to a particular processor implementation and are not architecturally required by the ISA.

For example, scan chains 56 may be provided to enable test data to be written into buffer or queue structures used for control purposes within the functional circuitry 6, to allow greater stress testing of components of the functional circuitry in a way that would be difficult (or at least inefficient) to achieve when relying on those structures being naturally updated during regular software processing without the ability to artificially inject arbitrary values into the micro-architectural storage elements 18 via the scan chains 56. As shown in FIG. 3, readout scan chains may also be provided to enable values to be read out from the internal storage 18. Each scan chain comprises a series of flip-flops which can be clocked to move data values in steps (cycle by cycle) from TAP 54 or test controller 58 to internal storage elements 18 and vice versa. Such a scan chain 56 is functionally a loop (e.g. looping out through an outbound part of the scan chain used to inject values and back through an inbound part of the scan chain used to read out values), but multiplexers/demultiplexers (not shown in this diagram) could be added to implement it as a tree structure which can be configured to scan chain 56 to access internal storage elements 18 in each sub region of the functional logic one at a time. The TAP 54 or test controller 58 may control the particular route taken by test data as it traverses the scan chains to or from a particular internal storage element 18. The particular test patterns injected via the scan chain 56 (which may vary in a number of respects, including varying the values specified for test data, the timing at which those values are applied, and the spatial selection of which internal storage elements 18 are injected with those values) may be specified by an external controller via the JTAG port 50 during manufacturing testing or in-field structural testing performed when the apparatus 2 is offline. In contrast, during in-field structural testing when the apparatus 2 is still operational in the field, the test patterns may be specified by the test controller 58 under control of software running on a secure processor node such as the system control processor 38 and/or LCPs 40 (in consultation with the RSE 34 which provides the cryptographic support for verifying root of trust to ensure that only trusted entities are able to make use of the TAP 54 and scan chains 56 of the DFT circuitry 8).

The apparatus 2 is logically divided into test domains, each with independent control over whether the DFT circuitry 8 for that domain is locked or unlocked. In some examples, each test domain 4 corresponds to a single compute tile 20. Other examples could split a single compute tile 20 into multiple test domains 4 (e.g. one test domain for the tile CPU 30 and one test domain for the accelerator 32). In some examples, more than one test controller 58 could be provided, e.g. with each test controller controlling a particular subset of these test domains. The test controller 58 for a given test domain could be controlled by an instance of system control processor 38 and/or local control processor 40.

FIG. 4 illustrates an example of components for isolating boundary signals of one test domain 4 from other test domains. In this example, the isolation logic 10 used to isolate the domain inputs and domain outputs (collectively referred to as domain boundary signals) from a given test domain is shared with logic which provides similar isolation functionality when the test domain 4 is placed in the power saving state by a power policy unit 41 which operates under control of the LCP 40 (in other examples, the power policy unit 41 and LCP 40 could be combined into a single entity, but it can be useful in some cases for the LCP 40 to be a software-programmable processor which can execute control software which programs the power policy unit 41 via a programming interface, while the power policy unit 41 is a fixed function unit responsible only for managing power transitions using dedicated hardware, but which has a limited amount of programmability based on the programming interface from the LCP 40). In other examples, rather than using the LCP 40 to control the power policy unit 41, the system control processor 38 could be used to control the power policy unit 41. Hence, there is flexibility to vary the way in which the isolation logic 10 is controlled.

To support one or more low-power states by which the test domain 4 can be powered down when not needed for functional processing, the power policy unit 41 has an associated interface by which it can control the test domain 4 to transition between power states. For example, the LPI (Low Power Interface) specification provided by Arm® Limited could be used to define the power control interface. The power policy unit 41 can also control clock gates 42 to disable transitions of a clock signal supplied to the functional circuitry 6 within the test domain 4, when the functional circuitry 6 enters a low power state in which the functional circuitry 6 is to be inactive. By preventing toggling of a clock signal, dynamic power consumption can be reduced (there is an energy cost associated with each transition of a signal between logical 0 and logical 1). To support use of low-power states, such that when the functional circuitry 6 of a given test domain is in the low power state its internal signal paths cannot be relied on to have well-defined signal values, isolation circuitry 10 is provided which clamps the domain outputs of the test domain 4 to predetermined values (e.g. reset values) and inserts test pattern values to domain inputs via scan chain 56. When the given test domain is in a normal operational state, the isolation circuitry 10 is disabled to allow domain inputs and domain outputs to propagate between the test domain 4 and the external components the domain is functionally connected to, to support the functional operations the domain is designed to perform.

FIG. 5 illustrates an example of lifecycle state transitions controlled by the RSE 34 for the apparatus 2. In this example, the lifecycle states include four states, namely a Chip Manufacturing state 60, a Device Manufacturing state 62, a Secure Enabled state 64 (an example of the in-field operational state mentioned earlier), and a Return Merchandise Authorization state 66. It will be appreciated that this is just one example of a lifecycle, and other examples could have a different set of lifecycle states.

Each lifecycle state is associated with different permissions which govern the extent to which various actions can be performed. For example, different lifecycle states may be associated with different rules for whether the DAP 52 is allowed to provide debug access to the functional logic, whether the TAP 54 and test controller 58 are allowed to have access to parts of the DFT circuitry, which parts of the DFT circuitry 8 can be unlocked, and/or whether the RSE 34 can update certain keys, certificates, one-time-password assets, etc. held in key storage 36 which represent the fundamental root of trust for the apparatus 2 that would be used to attest to the identity of the apparatus 2 when in the field.

The RSE 34 manages the transitions between the lifecycle states based on secure protocols which require that a transition from one state to another can only take place once a certificate provided by the agent requesting the lifecycle transition has been verified as being associated with a trusted entity. Some transitions may also require certain actions to be performed before the transition can be completed. The lifecycle transitions may be one-way, such that there is no way of reversing a transition from a later lifecycle state to an earlier lifecycle state while retaining information established for the device 2 in an earlier lifecycle state.

The chip manufacturing state 60 is intended for use from the birth (initial manufacture) of a chip or set of chips implementing the apparatus 2, through to a point at which initial secure provisioning of a device identity for the apparatus 2 is complete. During the chip manufacturing state 60, the RSE 34 can cause various one-time-password (OTP) assets to be initialised, such as device certificates, private keys, etc. associated with the device which represent the device's identity and can be used to attest to external verifiers the origins of the device (e.g. attesting that the device was made in a particular chip manufacturing site run by a particular entity, to enable decisions to be made by external verifiers on whether this chip can be trusted to behave correctly when processing sensitive information). In the chip manufacturing state 60, the test access ports 54 in the apparatus 2 may be fully open, to allow the chip manufacturer to perform detailed structural testing of the hardware components of each test domain 4, to check for defects that may have arisen during manufacture. However, the debug access ports (DAPs) 52 may be locked to prevent debug access during the chip manufacturing state 60 (there being no need to use the DAPs 52 at the manufacturing stage as the DAPs are intended for use instead by software developers when developing software for use on the device).

On transitioning from the chip manufacturing state 60 to the device manufacturing state 62 (e.g. when the chip 2 is passing from the initial chip manufacturer to a downstream electronic device manufacturer who is assembling the chip into a larger scale electronic device such as a mobile telephone, laptop computer, server, sensor device, etc.), the chip's OTP assets are frozen and can no longer be updated by RSE 34, but in the device manufacturing state 62 the device manufacturer may be able to perform secure provisioning of further device-manufacturer OTP assets (again, providing certificates, private keys, etc. which enable further attestations to the origin of the device comprising the chip 2). Hence, a root of trust can be established by which the device 2 can establish trust with external devices that interact with the device 2. In the device manufacturing state 62, the DAPs 52 remain locked, the TAPs 54 associated with structural testing of the RSE 34 become locked to prevent any external test access to scan chains associated with the RSE 34, but TAPs 54 associated with the test domains (e.g. the compute tiles 20) in the rest of the chip 2 can remain unlocked to enable the device manufacturer to continue to perform structural tests to check for hardware defects. It is not necessary for the device manufacturer (or a software process executing on the system control processor/LCP 38, 40) to supply a certificate to the RSE 34 to enable the TAPs associated with non-RSE test domains to be unlocked, while the current lifecycle state is the device manufacturing state 62. Hence, for both the chip manufacturing state 60 and device manufacturing state 62, test access to the DFT circuitry 8 is less restricted than in the secure enabled (in-field operational) state 64.

The transition from device manufacturing state 62 to secure enabled state 64 occurs when the device 2 is ready to be deployed in the field for its actual function. In the secure enabled state 64, the OTP assets associated with the chip manufacturer and device manufacturer cannot be updated by the RSE 34. In the secure enabled state 64, the DAPs 52, TAPs 54 and scan chains 56 are all considered locked by default, so that in absence of successful verification of a requester certificate provided by an external DFT-requesting agent, the DAPs 52 and TAPs 54 remain locked. Some DAPs 52 and TAPs 54 may be prohibited from being unlocked during the secure enabled state 62 (e.g. to maintain security, the TAPs 54 associated with the RSE 34 itself may be permanently locked during the secure enabled state). Other DAPs 52 and TAPs 54 (e.g. those associated with the compute tiles 20) can be unlocked following successful verification by the RSE 34 of a requester certificate provided by the agent seeking to cause the DAPs 52 or TAPs 54 to become unlocked. This enables debugging and in-field structural testing (when the SoC is taken offline when deployed to the field) to be performed in a securely controlled manner, while the device is operational in the field. In-field structural testing can be particularly useful for checking of hardware defects which develop over time (even if not initially present) due to silicon aging effects. For performing in-field structural testing when the SoC is In operational mode, The system control processor 38 or LCP 40 has to provide certificate to the RSE 34, and upon successful verification of such certificate, the RSE 34 unlocks the specific path of the scan chain that is used to control testing of the targeted part the functional logic, in some examples a selected tile.

The transition from secure enabled state 64 to return merchandise authorisation state 66 occurs when the device 2 is decommissioned and returned from the field to a manufacturer site (e.g. for investigation of defects that caused the device 2 to become defective). The transition from the secure enabled state 64 to the return merchandise authorisation state 66 may require all chip OTP assets and device OTP assets to be wiped from the key storage 36 of the RSE 34, so that it is not subsequent possible for the device 2 to return to its operational state while continuing to have the same device identity and root of trust. In the return merchandise authorisation state 66, the DAPs 52, TAPs 54 and the scan chains 56 may be fully unlocked (open) so that full investigation of any errors in operation of the device can be performed, e.g. to learn information about design bugs or hardware defects that might be addressed in future design iterations of the chip).

The ability to unlock the DFT circuitry 8 in one test domain 4, while another test domain 4 on the same integrated circuit die still has its DFT circuitry 8 locked and continues with regular non-DFT-related processing, can be particularly useful for the secure enabled lifecycle state 64 when the device is operational in the field, as it prevents the system control processor 38, LCP 40 and test controllers 58 from being used as attack surfaces to access scan chains 56 to steal or alter secure information in the SoC runtime environment.

The techniques discussed above supporting in-field structural testing while a deployed SoC is in operational mode can be particularly helpful for data centre applications where there can be a huge number of CPU cores 30 running a distributed workload load at the same time. If hardware defects cause the chip to malfunction so that the chip has to be brought offline, this can result in incorrect computation results and loss of computing time and ultimately cost money to the data centre operator. If something goes wrong with one chip, then the errors are compounded as the errors also spread to other chips that may be communicating with the chip, causing significant loss of performance and economic costs to the data centre operator. The performance of the chip can degrade over time due to silicon aging. This aging process is usually gradual over time, but it also can be spontaneous process. Sensors on-chip can measure different parameters which can predict when the chip might develop a fault (e.g. detecting when the chip is operating outside its preferred operating conditions (temperature, voltage, etc.) so as to detect when there is higher risk of wearout or development of hardware defects). However, this is not conclusive and imprecise in that it will be unable to predict at what point in time the chip might fail. Hence, it can be useful to continually test a system on chip when it is operational in the field, using the DFT type of in-field structural testing.

In an example implementation, a given number of functional tiles may be in the operational state for running a distributed workload at any one time. Stopping all the tiles to perform testing costs performance and money to the data centre operator if all the tiles are taken down at the same time. Also, for LLM models or other similar workloads, the computing load is significant and the task have to be distributed across the multiple tiles using a task manager. It may be desirable to maintain a constant number of available tiles throughout processing of a given workload. In order to do this the SoC includes at least one known good spare tile (preferably multiple spare tiles), and the spare tiles have two functions. One is for using the spare tile to support DFT testing as mentioned above (enabling the test target compute tile being tested to be replaced with the known good spare) and a second function is for an in-field repair mechanism when a tile is detected as being faulty, so that the faulty tile can be swapped out for the known good spare. To enable continued operation of the apparatus even if one or more tiles become faulty, a certain number of spare tiles may be supported (more than one spare tile). To support the substitution of the spare tile for the test target compute tile, the spare tiles are booted up by an operating system and so the operating system may be fully aware of all available tiles (both the first and second subsets) that are not faulty. However, switching the spare tile for the test target compute tile may be invisible to the application software.

FIG. 6 illustrates steps for performing in-field structural testing while a deployed SoC is in operational mode. At step 100, a distributed processing workload is processed using a first subset of compute tiles 20 operating in an operational state, while the second subset of compute tiles 20 are in a non-operational state unused for processing the distributed processing workload. Although the second subset of compute tiles are non-operational in the sense that they are not being used for processing the distributed processing workload, they can still be in a power-up state having previously been booted by the system control processor 38/LCP 40 at boot time (e.g. internal registers and other storage elements may have been initialised ready for the spare second subset of compute tiles to accept part of the workload later). At step 102, a test trigger event is detected. For example, the test trigger event may be the system control processor 38/LCP 40 issuing a request that a particular test target compute tile 20 is to be subject to in-field structural testing, to run test algorithms on the compute tile 20 designed to probe whether any hardware components are faulty. In response to the test trigger event, at step 104, the in-field structural test infrastructure 12 substitutes a spare compute tile of the second subset for the test target compute tile of the first subset (with the spare compute tile therefore becoming one of the first subset of compute tiles and the test target compute tile becoming one of the second subset of compute tiles, as a result of the swap). This maintains a constant number of compute tiles 20 available in the operational state for processing the distributed processing workload, which is helpful for LLM processing or other similar workloads where portions of the workload assigned to different compute tiles 20 may be heavily inter-dependent (so that losing the computational resource of a single compute tile may have a severe knock-on effect in slow latency for a number of other compute tiles 20 that remain operational), and for which the job manager 14 may be much simpler to implement if the partitioning of the workload into portions to execute in parallel on the compute tiles 20 can always assume a constant number of compute tiles are available. At step 106, having swapped the spare compute tile for the test target compute tile, the in-field structural testing is performed on the test target compute tile, e.g. by scanning in test patterns using the scan chains 56 of the DFT circuitry 8 for that compute tile, executing one or more test operations on the functional circuitry 16 of the compute tile, and then reading out values from internal storage elements 18 (e.g. flip-flops) of the functional circuitry 16 using the scan chains 56, and comparing those values with expected results to detect whether any error has occurred.

In one example, step 104 is performed by an Operating System (OS) executing on a processor (e.g. CPU 20), which selects an operational tile to be tested and a spare tile to be used as a substitute and is responsible for any context save and restore respectively in these two tiles. The OS then requests a software-programmable processor (e.g. the Local Control Processor 40 in the example in FIG. 4) to isolate and de-isolate respectively the two tiles being swapped. Once the targeted tile to be tested is isolated, at step 106 a software-programmable processor (e.g. LCP 40) controls the test controller 58 to scan in the test pattern and perform the test.

FIGS. 7 and 8 show two alternative approaches to controlling the substitution at step 104 of FIG. 6. In the example of FIG. 7, the in-field structural test infrastructure 12 waits until the test target compute tile has finished its current portion of the distributed workload, before performing the substitution. Hence, at step 120 the in-field structural test infrastructure 12 checks whether the current portion of the distributed workload is completed by the test target compute tile, and once this is complete, at step 122 substitutes the spare compute tile for the test target compute tile as discussed earlier (the spare compute tile is switched to the operational state and the test target compute tile is switched to the non-operational state). At step 124, another portion of the distributed processing workload (different to the current portion previously completed by the test target compute tile) is started on the spare compute tile. Hence, as the current portion was fully completed by the test target compute tile before the substitution is made, the amount of internal context information required to be transferred from the test target compute tile to the spare compute tile to enable the spare compute tile to take over processing of the distributed workload can be greatly reduced. By timing the substitution to occur at a natural point at which a given chunk of processing is complete, the latency of state save/restore operations (which can otherwise be costly because, especially for the accelerator 32 such as a neural engine (NE), the volume of internal context state can be large) can be significantly reduced.

FIG. 8 shows an alternative implementation of step 104 in which, rather than waiting for the current portion of the distributed workload to complete at the test target compute tile, the current portion is interrupted, but then restarted in its entirety at the spare compute tile (discarding any temporary results of the current portion that had already been calculated at the test target compute tile before the interruption, and re-computing those results on the spare compute tile). While this might seem inefficient, in practice the added latency of re-computing already calculated results may be lower than the latency of the save/restore operations, given the large amount of temporary state information that may be generated by the accelerator 32 of a given compute tile part way through a chunk of the distributed workload. Hence, at step 130, the in-field structural test infrastructure 12 controls the test target compute title to halt its current portion of the distributed processing workload partway through (in some examples, at step 130 a small amount of CPU context relating to the software runtime environment (e.g. operating system) executing on the test target compute tile may be saved to memory, but there is no need to save the much larger accelerator context associated with the accelerator 32). At step 132 the substitution of the test target compute tile and the spare compute tile is performed in the same way as at step 122 of FIG. 7. In some examples, at step 132, the CPU context saved at step 130 may be restored to the spare compute tile (and again, there is no need to restore the accelerator context). At step 134, the in-field structural test infrastructure 12 controls the current portion of the distributed processing workload to be re-started on the spare compute tile which is now operational (in its entirety, including any operations of the current portion that had already completed on the test target compute tile prior to the interruption at step 130).

In some examples, the apparatus 2 may be implemented as a system-on-chip on a single integrated circuit die.

However, other examples may provide an apparatus 2 comprising a packaged chip comprising multiple integrated circuit dies, e.g. with 2.5D or 3D integration of dies. In so-called 2.5D integration, two or more dies can be mounted side-by-side on a base die or interposer, with the base die or interposer providing die-to-die communication between the side-by-side mounted dies. In 3D integration, two or more dies can be stacked vertically (e.g. face to face, back to back, or face to back), with inter-layer communication paths provided between different layers of circuit dies (e.g. through silicon vias passing through a silicon substrate in the case of back to back or face to back integration, or bonded connections in the case of face to face integration).

FIG. 9 shows a first example of a packaged chip comprising a number of dies. For example, the chip may comprise a base die 80 providing a base layer (e.g. the base die 80 can include support circuitry such as the housekeeping CPU 24, I/O circuitry 26, system control processor 38, RSE 34 etc.), a compute die layer stacked on the base die 80 providing a number of side-by-side compute dies 82 implemented with 2.5D integration between the compute dies 82, and a coherent mesh network die 83 which is stacked on the compute die layer and provides the interconnect 22 which communicates between respective compute tiles 20 on the respective compute dies 82.

FIG. 10 shows a second example of a packaged chip comprising multiple dies. In this example, rather than mounting compute dies 82 side-by-side on top of the base die, respective compute dies 82 are stacked on top of each other vertically.

FIGS. 9 and 10 are just some possible examples of how multiple compute dies 82 (each comprising a number of compute tiles 20) can be integrated into a packaged chip. In both cases, as shown in FIG. 11, it is possible to support the substitution of a spare compute tile on one die 82 for a test target compute tile 20 being swapped out for structural testing on another die 82, to give more flexibility for varying which compute tiles 20 are operational, e.g. to account for the fact that one of the dies 82 has suffered a disproportionate number of faulty tiles so that it is preferable that when one of the compute tiles 20 on that die needs to be tested, it is replaced by a spare compute tile 20 from another die 82.

Concepts described herein may be embodied in a system comprising at least one packaged chip. The apparatus 2 described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

As shown in FIG. 12, one or more packaged chips 400, with the apparatus described above implemented on one chip or distributed over two or more of the chips, are manufactured by a semiconductor chip manufacturer. In some examples, the chip product 400 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 400 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 400 are assembled on a board 402 together with at least one system component 404 to provide a system 406. For example, the board may comprise a printed circuit board. The board substrate may be made of any of a variety of materials, e.g. plastic, glass, ceramic, or a flexible substrate material such as paper, plastic or textile material. The at least one system component 404 comprise one or more external components which are not part of the one or more packaged chip(s) 400. For example, the at least one system component 404 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 416 is manufactured comprising the system 406 (including the board 402, the one or more chips 400 and the at least one system component 404) and one or more product components 412. The product components 412 comprise one or more further components which are not part of the system 406. As a non-exhaustive list of examples, the one or more product components 412 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 406 and one or more product components 412 may be assembled on to a further board 414.

The board 402 or the further board 414 may be provided on or within a device housing or other structural support (e.g. a frame or blade) to provide a product which can be handled by a user and/or is intended for operational use by a person or company.

The system 406 or the chip-containing product 416 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

In the present application, the words “configured to” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: [A], [B] and [C]” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. A method for a processing system comprising a plurality of compute tiles, comprising:
processing a distributed processing workload using a first subset of the compute tiles operating in an operational state, while a second subset of compute tiles of the integrated circuit are in a non-operational state unused for processing the distributed processing workload; and
in response to a test trigger event indicating that a test target compute tile of the first subset is to be selected for in-field structural testing of the test target compute tile:
substituting a spare compute tile from the second subset of compute tiles for the test target compute tile, to switch the spare compute tile to become one of the first subset of compute tiles configured to process the distributed processing workload in the operational state and switch the test target compute tile to become one of the second subset of compute tiles in the non-operational state; and
performing the in-field structural testing on the test target compute tile.

2. The method according to claim 1, in which substituting the spare compute tile for the test target compute tile maintains a constant number of compute tiles available in the operational state for processing the distributed processing workload.

3. The method according to claim 2, in which the first subset of the compute tiles are selected from among a booted subset of compute tiles booted at boot time of the processing system, and the booted subset comprises a greater number of compute tiles than said constant number.

4. The method according to claim 1, in which each compute tile comprises at least one tile CPU.

5. The method according to claim 4, in which each compute tile also comprises a hardware accelerator.

6. The method according to claim 5, in which the hardware accelerator comprises accelerator circuitry configured to accelerate operations for one or more machine learning workloads.

7. The method according to claim 1, comprising, in response to the test trigger event:
waiting for completion of a current portion of the distributed processing workload to be completed by the test target compute tile; and
upon completion of the current portion by the test target compute tile, substituting the spare compute tile for the test target compute tile and starting another portion of the distributed processing workload on the spare compute tile.

8. The method according to claim 1, comprising, in response to the test trigger event:
halting a current portion of the distributed processing workload part way through processing of the current portion on the test target compute tile;
substituting the spare compute tile for the test target compute tile; and
re-starting, from a beginning of the current portion, the current portion on the spare compute tile.

9. The method according to claim 1, in which the processing system comprises a plurality of integrated circuit dies; and
the test target compute tile and the spare compute tile are on different integrated circuit dies of the plurality of integrated circuit dies.

10. The method according to claim 9, in which the plurality of integrated circuit dies are coupled via a shared memory system interconnect.

11. The method of claim 10, in which the shared memory system interconnect comprises a coherent mesh network.

12. The method according to claim 1, in which each compute tile comprises functional circuitry and design-for-test (DFT) circuitry to provide test access to the functional circuitry for performing the in-field structural testing.

13. The method according to claim 12, in which the DFT circuitry comprises at least one scan chain configured to inject test values into internal storage elements of the functional circuitry of the compute tile.

14. The method according to claim 12, in which the in-field structural testing comprises stimulating the functional circuitry according to a test sequence controlled by test software executing on at least one software-programmable processor.

15. The method according to claim 1, in which the in-field structural testing comprises testing for hardware defects.

16. A computer program comprising instructions which, when executed on a processing system control the processing system to perform the method of claim 1.

17. An apparatus comprising:
a plurality of compute tiles configured to process a distributed processing workload using a first subset of the compute tiles operating in an operational state, while a second subset of compute tiles of the integrated circuit are in a non-operational state unused for processing the distributed processing workload; and
in-field structural testing infrastructure configured to control in-field structural testing of the test target compute tile;
wherein, in response to a test trigger event indicating that a test target compute tile of the first subset is to be switched from the operational state to the non-operational state to support in-field structural testing of the test target compute tile, in-field structural testing infrastructure is configured to:
substitute a spare compute tile from the second subset of compute tiles for the test target compute tile, to switch the spare compute tile to become one of the first subset of compute tiles configured to process the distributed processing workload in the operational state and switch the test target compute tile to become one of the second subset of compute tiles in the non-operational state; and
control the in-field structural testing to be performed on the test target compute tile.

18. A system comprising:
the apparatus according to claim 17, implemented in at least one packaged chip;
at least one system component; and
a board,
wherein the at least one packaged chip and the at least one system component are assembled on the board.

19. A chip-containing product comprising the system of claim 18, wherein the system is assembled on a further board with at least one other product component.

20. Computer-readable code for fabrication of an apparatus according to claim 17.
